(19) United States
(12) Patent Application Publication
(10) Pub. No.: US 2026/0160352 A1
(43) Pub. Date: Jun. 11, 2026

(54) Actuator Module For A Fluid Valve And Fluid Valve Comprising Such A Module

(71) Applicant: ECO Holding 1 GmbH, Marktheidenfeld (DE)

(72) Inventors: Toni Schneider, Esslingen (DE); Manuel Alt, Stuttgart (DE); Adrian Eslava Orradre, Nürtingen (DE)

(73) Assignee: ECO Holding 1 GmbH, Marktheidenfeld (DE)

(21) Appl. No.: 19/413,070

(22) Filed: Dec. 9, 2025

(30) Foreign Application Priority Data
Dec. 11, 2024 (DE) 10 2024 137 135.8

(51) Int. Cl. F16K 31/04

(52) U.S. Cl. CPC F16K 31/04

(57) ABSTRACT

An actuator module for a fluid valve, includes a shaft and a rotor which is arranged in a containment shroud, wherein the containment shroud has a first end for connection to a valve housing and a second end arranged opposite the first end, and wherein the shaft is mounted rotatably in the containment shroud at the first end by a first bearing and at the second end by a second bearing, wherein the first bearing and the second bearing are each configured as a plain bearing, wherein the first bearing forms a combined radial-axial bearing and the second bearing forms a radial bearing.

### CROSS REFERENCE TO RELATED APPLICATIONS

The present application claims priority from German Patent Application No. 10 2024 137 135.8 filed Dec. 11, 2024, the disclosure of which is hereby incorporated herein by reference.

### FIELD OF THE DISCLOSURE

The present invention relates to an actuator module for a fluid valve which is arranged, in particular, in a refrigerant circuit of an electrically driven vehicle. Furthermore, the invention relates to a fluid valve comprising such an actuator module, in particular a fluid valve for use in a refrigerant circuit of an electrically driven vehicle.

### BACKGROUND OF THE DISCLOSURE

It is known to provide actuator devices for valves which are driven on the basis of a stator/rotor principle. For this purpose, a rotor assembly comprising a rotor shaft, a rotor arranged thereon and configured to be rotatable therewith, and a rotor sleeve within which the rotor and the rotor shaft are received at least in areas, as well as a stator assembly which is provided externally around the rotor sleeve, are provided. In order to achieve a sufficient efficiency of the actuator motor, it is necessary to ensure a precise alignment of the rotor assembly with respect to the stator assembly. The rotor shaft and, with it, the rotor is rotatably mounted within the rotor sleeve. In order to fix the rotor shaft radially and axially in the rotor sleeve, a ball bearing is usually arranged.

A disadvantage of such a ball bearing is that it presents a relatively high inherent weight, is expensive and requires a large mounting space. The precise alignment of the rotor assembly with respect to the stator assembly is also usually associated with a high assembly effort and is therefore difficult. Since the ball bearing itself requires a large mounting space, it is difficult to keep an air gap between the rotor sleeve and to keep the rotor small, which in turn negatively affects the efficiency of the motor.

### BRIEF SUMMARY OF THE DISCLOSURE

It is therefore the object of the invention to provide an actuator module belonging to the technical field mentioned in the introduction, which at least partially overcomes the disadvantages from the prior art. It is the object of the present invention to provide an improved concept of an actuator module. In particular, it is the object of the present invention to improve the efficiency of the actuator module and at the same time to provide a compact, space-saving actuator module.

Overall, the object on which the present invention is based is achieved by the subject matter of independent claim 1 and by the subject matter of ancillary claim 16. Advantageous developments are specified in the dependent claims.

More precisely, the object on which the present invention is based is achieved by an actuator module for a fluid valve according to the subject matter of independent claim 1. For this purpose, the actuator module comprises a shaft as well as a rotor, which is arranged in a containment shroud. The containment shroud comprises a first end for connection to a valve housing and a second end arranged opposite the first end. The shaft is mounted rotatably in the containment shroud at the first end by a first bearing and at the second end by a second bearing. The first bearing and the second bearing are both configured as plain bearings. The first bearing forms a combined radial-axial bearing and the second bearing forms a radial bearing.

In this context, a radial-axial bearing is understood to mean a bearing that is configured to absorb both forces acting in the radial direction as well as forces acting in the axial direction. Accordingly, a radial bearing is understood to mean a bearing that is configured to absorb forces acting in the radial direction. However, a radial bearing is not configured to absorb forces acting in the axial direction.

According to the invention, both the first bearing and the second bearing are configured as plain bearings, wherein the first bearing is configured as a radial-axial bearing and the second bearing is configured as a pure radial bearing.

In this context, for example, the technical advantage is achieved that a plain bearing is lighter and requires less room than the ball bearings commonly used. In addition, it is more cost-effective to produce. The small space requirement and the low weight make it possible to configure the actuator module in such a way that the air gap between the rotor and the containment shroud can be kept extremely small, which improves the efficiency of the actuator module.

Furthermore, the actuator module can be assembled easily and quickly. In particular, the insertion of the shaft into the second bearing configured as a radial bearing already results in a centering of the individual components, as a result of which the alignment of the rotor assembly within the containment shroud is less complex. Nevertheless, an extremely precise rotor mounting in the radial and axial direction can be achieved.

The structure of the actuator module according to the invention is constructed in modular subassemblies, such that the individual subassemblies are easy to assemble, service, repair and/or replace. This reduces assembly and maintenance times, as well as the associated costs.

Furthermore, the actuator module according to the invention can be simply plugged onto a valve as a whole and can be connected thereto. This facilitates the assembly effort.

According to an advantageous development of the actuator module, the second bearing is configured in one piece, in particular monolithically, with the containment shroud. As a result, for example, the technical advantage is achieved that the number of individual components can be reduced. As a result, the actuator module can be assembled more easily and is more cost-effective overall.

Advantageously, the containment shroud is produced from a suitable metal such as stainless steel or a suitable metal alloy, which comprise the property of impairing the magnetic field only to a small extent or not at all. In this case, aluminum is preferred. Alternatively, it is conceivable to produce the containment shroud from a plastic material or a plastic composite, which comprise good anti-friction properties. For example, PA, POM, and/or rigid PVC are suitable for this purpose.

According to an advantageous development of the actuator module, the second bearing is formed by a, in particular cylindrical, bulge of the second end of the containment shroud. This results, for example, in the technical advantage that the alignment of the shaft in the containment shroud and therefore also the alignment of the rotor in the containment shroud can take place in an extremely precise and simple manner. In particular, the, preferably cylindrical, bulge is arranged such that a center axis, along which the containment shroud and the bulge are configured to be symmetrical in section, in particular about which the containment shroud and the bulge are configured to be rotationally symmetrical, is coaxial with the longitudinal axis of the shaft. The function of the bulge as a bearing therefore results in an automatic centering of the shaft and of the rotor in the containment shroud.

Alternatively, it is also conceivable that, instead of the bulge, the second end of the containment shroud is configured as a closed, in particular planar, base, and a cylindrical wall projecting inwards from the base in the direction of the first end of the containment shroud is configured integrally with the containment shroud, said cylindrical wall fulfilling the function of the second bearing, which is configured as a radial bearing. The second bearing therefore comprises a shroud-like structure.

According to an advantageous development of the actuator module, the first bearing is formed by a plain bearing bushing which is fixedly connected, in particular welded, to the containment shroud. In particular, the plain bearing bushing is arranged at the first end of the containment shroud and comprises a dual function in that the plain bearing bushing forms a combined radial-axial bearing for the shaft and closes the containment shroud at the first end. A functional, closed rotor assembly is therefore formed. This modular construction achieves, for example, the technical advantage that the actuator module can be handled easily and in particular as a whole. In other words, the actuator module can be arranged as a whole on an associated fluid valve. This facilitates the alignment and precise positioning of the actuator module on the fluid valve.

The plain bearing bushing is advantageously formed from the same material as the containment shroud, or at least the materials of the plain bearing bushing and of the containment shroud are formed so as to be compatible with one another, for example in order to be fixedly connected, in particular welded, to one another. For example, the plain bearing bushing is to be manufactured from a metal such as stainless steel or a metal alloy, for example aluminum. Alternatively, it is also conceivable to manufacture the plain bearing bushing from a hard plastic material or a plastic composite, which comprise good anti-friction properties. For example, PA, POM, and/or rigid PVC are suitable for this purpose.

According to an advantageous development of this actuator module, the plain bearing bushing is configured in one piece, in particular as a deep-drawn element. This presents, for example, the technical advantage that the plain bearing bushing can be manufactured in a precise and simple manner.

According to an advantageous development of the actuator module, the plain bearing bushing comprises an engagement element which supports the shaft in a form-fitting manner in the axial direction. This presents, for example, the technical advantage that an axial securing of the shaft is achieved by means of the engagement element of the plain bearing bushing and a radial securing of the shaft is achieved by means of the remaining regions of the plain bearing bushing. Thus, an extremely precise rotor mounting in both the radial and the axial direction can be provided in a simple manner.

According to an advantageous development of this actuator module, the engagement element engages in a contour of the shaft. This achieves, for example, on the one hand the advantage that the axial bearing action can be improved by means of the engagement of the engagement elements in the contour of the shaft and, on the other hand, the assembly of the rotor assembly is also simplified. In particular, the plain bearing bushing can be simply pushed onto the shaft until the engagement elements engage in the contour configured in the shaft.

In particular, the contour can be configured circumferentially around the shaft. For example, the circumferential contour can be configured as an annular groove. The cross-section in a sectional view of the annular groove can be configured, for example, to be rectangular, rectangular with rounded corners, semicircular or also trapezoidal, in particular so that undercuts are formed, in which the engagement element of the plain bearing bushing can engage. In principle, any form is conceivable which can exert a sufficient axial securing of the shaft in engagement with the engagement elements of the plain bearing bushing.

According to an advantageous development of the actuator module, the engagement element forms a snap-on or latching connection with the contour. This achieves, for example, the technical advantage that a precise and secure rotor mounting in the radial and axial direction can be provided using comparatively simple means and the assembly effort can be kept low or even be reduced in comparison to the installation of a ball bearing.

According to an advantageous development of this actuator module, the engagement element engages in the contour of the shaft from the second end in the direction of the first end.

In other words, the engagement elements extend, as seen from the plain bearing bushing, from an end of the plain bearing bushing which is arranged close to the second end of the containment shroud in the direction of the first end of the containment shroud and engage there in the contour on the shaft. This presents, for example, the technical advantage that, when connecting the rotor unit or the actuator module to the valve body of the fluid valve, the assembly forces which act on the shaft at least essentially in the axial direction of the shaft in the direction of the second end can be better absorbed. In other words, a more secure connection can be created between the shaft and the plain bearing bushing, which is configured to be less sensitive to any assembly forces acting.

According to an advantageous development of the actuator module, the engagement element supports the shaft at least partially in the axial direction. A precise mounting of the rotor in the axial and radial direction can therefore advantageously be ensured.

According to an advantageous development of the actuator module, the plain bearing bushing comprises at least two engagement elements, in particular arranged opposite one another, or at least three engagement elements, in particular arranged equidistant from one another. This presents, for example, the technical advantage that the forces acting in the axial direction are absorbed in a distributed manner by a plurality of engagement elements. As a result, each individual engagement element is subjected to a lower load. The preferably equidistant arrangement additionally presents the technical advantage that a uniform weight and force distribution can be achieved by the uniform arrangement.

Alternatively, it is also conceivable for the plain bearing bushing to comprise only a single engagement element which is then configured to be relatively wide. In particular, the width of the engagement element, measured in terms of angular dimension, extends from 45° to 180°, preferably from 60° to 120°. This presents the advantage that the manufacturing of the plain bearing bushing can be simplified.

According to an advantageous development of the actuator module, the rotor comprises an outer casing, wherein the casing comprises a magnetizable or magnetized material. This presents the technical advantage that parts, in particular a rotor core arranged within the outer casing, do not have to be made of magnetizable or magnetized material. Rather, the rotor core can be produced from lighter and more favorable materials, in particular a plastic material or a plastic composite. The weight of the actuator module can therefore be reduced, in particular without negatively influencing the performance or efficiency.

According to an advantageous development of this actuator module, the magnetizable or magnetized material comprises or consists of neodymium.

Alternatively, it is also conceivable to use a magnetizable or magnetized material that does not belong to the rare earths. For example, a simple magnetizable casing or a magnetizable pipe section can be used, which is produced by a pressing method or a sintering method. Therefore, the rotor core can assume functions independently of the casing geometry, whereby the functions of casing and rotor core can be separable and expanded independently of the respective material selection.

According to an advantageous development of the actuator module, the magnetizable or magnetized material is embedded in a plastic material, in particular mixed with a plastic material. The weight of the rotor can therefore advantageously be kept low.

Alternatively, it is also conceivable to form the outer casing from a sintered ferritic magnetizable or magnetized material. This presents the advantage that no plastic bond is necessary and the efficiency of the rotor can be improved as a result.

According to an advantageous development of the actuator module, the shaft is formed from a, in particular non-magnetic, plastic material. This presents, for example, the technical advantage that the weight of the actuator module can be further reduced.

Furthermore, it is conceivable, for example, for the actuator module to be formed at the first end of the containment shroud as a standardized interface which is configured in such a way that it can be universally connected to different valves. In other words, the same actuator module can be connected to different valves in the same manner. A high flexibility of use can therefore advantageously be provided.

According to a further advantageous configuration of the actuator module, the casing of the rotor is configured close to the first end of the containment shroud with an inner recess which is configured to receive the first bearing at least in regions. In particular, the inner recess of the casing is shaped such that at least one region of the plain bearing bushing is received in the recess of the casing.

The object on which the present invention is based is furthermore achieved by a fluid valve which comprises one of the actuator modules described above.

In this context, the advantages described above in connection with the actuator module also apply correspondingly to the fluid valve.

Further advantageous embodiments and combinations of features of the invention result from the following detailed description and the entirety of the patent claims.

### BRIEF DESCRIPTION OF THE DRAWINGS

The above-described, different and exemplary features can be combined with one another according to the invention, insofar as this is technically useful and appropriate. Further features, advantages and embodiments of the invention result from the following description of exemplary embodiments and with reference to the figures.

The drawings used to explain the exemplary embodiments show the following:

FIG. 1 a schematic sectional representation of a fluid valve according to the invention;

FIG. 2 a schematic view of the actuator module according to the invention;

FIG. 3a a schematic view of a plain bearing bushing according to a first embodiment of the invention;

FIG. 3b a schematic sectional illustration of the plain bearing bushing according to the first embodiment in the installed state;

FIG. 4a a schematic view of a plain bearing bushing according to a second embodiment of the invention;

FIG. 4b a schematic sectional representation of the plain bearing bushing according to the second embodiment in the installed state;

FIG. 5a a schematic view of a plain bearing bushing according to a third embodiment of the invention; and

FIG. 5b a schematic sectional representation of the plain bearing bushing according to the third embodiment in the installed state.

### DETAILED DESCRIPTION

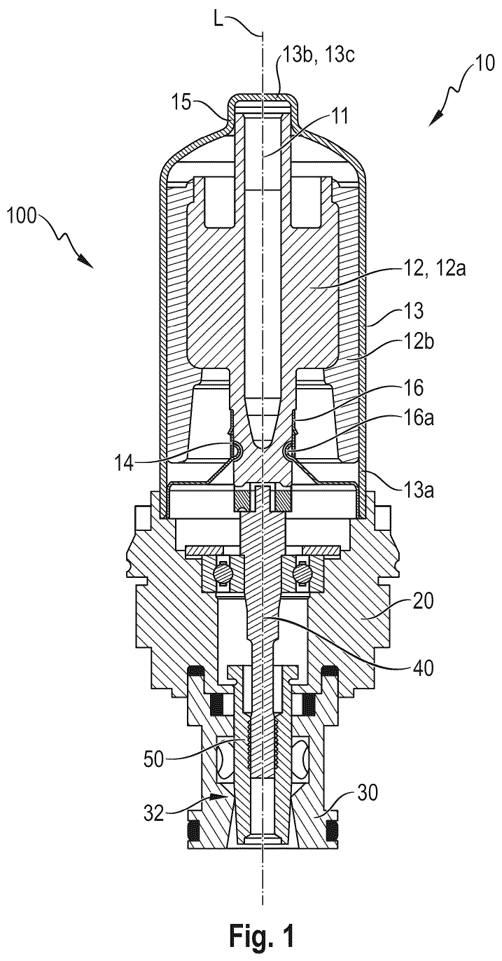

FIG. 1 shows a schematic representation of a fluid valve 100 according to the invention for blocking and/or controlling a throughflow of fluids. The fluid valve 100 comprises a valve body 50 which is configured in such a way that it can be transferred between a fully closed position and a fully open position within a fluid housing 30. In the fully closed position, the valve body 50 bears against a sealing seat 32 of the fluid housing 30 or extends into the sealing seat 32 in such a way that a first inlet and/or outlet opening is fully closed, as a result of which a fluid flow through the fluid housing 30 is not possible. in the fully open position, the valve body 50 is removed from the sealing seat 32 or retracted out of the sealing seat 32 to such an extent that the first inlet and/or outlet opening is at least partially exposed, as a result of which a fluid flow through the fluid housing 30 is possible.

The valve body 50 is driven with the aid of an actuator module 10. The actuator module 10 comprises a rotor 12 arranged within a containment shroud 13 and stator windings (not shown in FIG. 1) arranged around the containment shroud 13. The containment shroud (13) is configured so as to be at least essentially pot-shaped. In particular, it is configured to be open at a first end 13a. At a second end 13b opposite the first end 13a, the containment shroud 13 forms a closed base. This facilitates the assembly of the rotor unit of the actuator module 10.

The rotor 12 and a shaft 11 are arranged in the containment shroud. The shaft 11 is configured in a rotationally fixed manner with the rotor 12 and executes a rotational movement together with the rotor 12. The rotor 12 can comprise or consist of a rotor core 12a and a rotor casing 12b arranged around the rotor core 12a.

The rotor core 12a can be configured in one piece with the shaft 11. The rotor core 12a is advantageously formed together with the shaft 11 as an integral injection-molded part. In particular, a hard, in particular more cost-effective, plastic or plastic composite is suitable as material.

The rotor casing 12b can comprise a magnetizable or magnetized material, such as for example neodymium or another magnetizable or magnetized material that is not based on the rare earths. For example, the magnetizable or magnetized material can be embedded at least in regions, in particular completely, in a plastic material. In other words, the rotor casing 12b can be formed from a plastic material in which the magnetizable or magnetized material is embedded, or the rotor casing 12b can be formed from a plastic material with which the magnetizable or magnetized material is mixed.

Alternatively, it is also conceivable to produce the rotor casing 12b from a sintered, ferritic magnetizable or magnetized material instead of a magnetizable or magnetized material embedded in plastic.

The shaft 11 comprises a first end and a second end opposite the first end. In order to save weight, the shaft 11 can be configured to be hollow from the second end at least in regions with a recess extending in the axial direction L, wherein the shaft 11 is configured to be closed at its first end, i.e. not hollow.

The shaft 11 is mounted at its first end by means of a first bearing 14 and at its second end by means of a second bearing 15 in the containment shroud 13 of the actuator module 10. The first bearing 14 is configured here as a combined radial-axial bearing and the second bearing as a radial bearing. Both the first bearing 14 and the second bearing 15 are designed as plain bearings.

The second bearing 15 can be configured in one piece, in particular monolithically, with the containment shroud 13.

A bulge 13c, which forms the second bearing 15, can be configured in a central region of the base of the containment shroud 13. The bulge 13c extends outwards from the base of the containment shroud 13, i.e. in the opposite direction to the first end 13a of the containment shroud 13. The bulge 13c can be cylindrical. In particular, the containment shroud 13 is configured in such a way that the bulge 13c forms a radial bearing for the shaft 11. In other words, the bulge 13c at the second end 13b of the containment shroud 13 receives the second end of the shaft 11 and supports it from a radial perspective.

The first end 13a of the containment shroud 13 can be closed by means of a plain bearing bushing 16. The plain bearing bushing 16 in this case forms the first bearing 14 for the first side of the shaft 11.

After the shaft 11 is inserted together with the rotor 12 in the containment shroud 13, and, in particular, the second end of the shaft 11 is received in a mounted manner in the bulge 13 c at the second end 13 b of the containment shroud 13, the first end 13 a of the containment shroud 13 is closed with the aid of the plain bearing bushing 16. For this purpose, the plain bearing bushing 16 comprises a central opening which is pushed onto the first end of the shaft 11 and forms a radial bearing region.

Preferably, the region of the shaft 11, which is covered by the plain bearing bushing 16, is machined such that a smooth surface and good anti-friction properties can be achieved and is not configured to be hollow. The step produced by means of the machining of the shaft 11 can at the same time serve as an axial contact surface of the plain bearing bushing 16, up to which the plain bearing bushing 16 is pushed onto the shaft 11.

The plain bearing bushing 16 is shaped in such a way that an outer circumferential surface of the plain bearing bushing 16 is inserted, in particular in a form-fitting manner, into the first end 13a of the containment shroud 13 and is fixedly connected, in particular flush, to the containment shroud 13. Preferably, the containment shroud 13 and the outer circumferential surface of the plain bearing bushing 16 are welded to one another. The plain bearing bushing is configured so as to be at least essentially stepped between the central opening and the outer circumferential surface.

On the first side of the shaft 11, a circumferential contour 11a is machined into the shaft 11. For example, the contour 11a is configured as an annular groove. In this case, an annular groove is not limited to a semicircular cross-section. A triangular, at least essentially rectangular, trapezoidal cross-section or the like is also conceivable. However, a more complicated contour 11a with one or more undercuts could also be formed.

The plain bearing bushing 16 comprises, in a region close to the central opening, one or more engagement elements 16a which are configured to engage in the circumferential contour 11a of the shaft 11. The engagement elements 16a of the plain bearing bush 16 can therefore also absorb forces acting in the axial direction L. In particular, the engagement elements 16a can each be configured to support the shaft 11 in a form-fitting manner in the axial direction. The plain bearing bush 16 therefore fulfills the function of a combined radial-axial bearing.

The engagement elements 16a can each comprise, at their free end, a latching element which is configured to engage in the circumferential contour 11a of the shaft 11.

The plain bearing bushing 16 can advantageously be configured as a deep-drawn part. The at least one engagement element 16a is configured integrally with the plain bearing bushing 16. For example, the at least one engagement element 16a can be machined into a plain bearing bushing blank, in particular a deep-drawn plain bearing bushing blank, by means of separating and forming manufacturing methods. For example, the contour of the engagement element 16a can be machined into the deep-drawn plain bearing bushing blank by cutting, in particular laser cutting, and the latching element can be formed at the free end of the engagement element 16a by a forming manufacturing step, such as bending, for example.

The at least one engagement element 16a of the plain bearing bushing 16 is configured at least essentially as an engagement arm, the free end of which comprises a bend or a buckling which engages in the circumferential contour 11a on the shaft 11. The free end of the at least one engagement element 16a could also be configured as a type of barb, which hooks into the circumferential contour 11a, in particular in the event that the circumferential contour 11a comprises an undercut. Alternatively, the latching element at the free end of the at least one engagement element 16a could also be configured as a latching lug.

The containment shroud 13, the rotor 12, the shaft 11 and/or the plain bearing bushing 16, advantageously all of them, can be configured coaxially. The containment shroud 13 is advantageously configured in such a way that the rotor 12, the shaft 11 and the plain bearing bushing 16 are arranged completely within the containment shroud 13. A compact actuator module 10 can therefore be created, the axial overall length of which is advantageously reduced.

The actuator module 10 can be configured to be universally attachable to different valves and valve types. In particular, the first end of the shaft 11 forms an interface which can be universally connected to different actuating elements of different valves. For connection to an associated valve, the actuator module 10 can be plugged onto and arranged in a valve body 20 or in a receiving space of the valve body 20 defined, for example, with the aid of a counterbore.

As shown in FIG. 1, the first end of the shaft 11 comprises an interface by means of which the shaft 11 can be or is connected in a rotationally fixed manner to a second end of a spindle 40 of the fluid valve 100. In other words, when the actuator module 10 is plugged into the receiving space of the valve body 20 and the shaft 11 is coupled in a rotationally fixed manner to the spindle, the rotational movement of the shaft 11 is transmitted to the spindle 40. For this purpose, the spindle 40 is mounted axially and radially in the valve body 20 via a ball bearing. At a first end opposite the second end, the spindle 40 comprises an external thread.

The valve body 50 of the fluid valve 100 can be configured at least essentially as a hollow shaft with a first end and a second end opposite the first end. In the installed state of the fluid valve 100, the second end of the valve body 50 lies closer to the actuator module 10 than the first end of the valve body 50.

The opening of the valve housing 20, through which the valve body 50 can be guided or is guided, and/or the opening in the fluid housing 30, through which the valve body can be guided or is guided in a form-fitting manner, comprise an anti-rotation means, for example in the form of a pin or projection. A correspondingly complementarily configured structure is configured in the second end of the valve body 50, for example a groove which extends in the axial direction L of the valve body 50 and which engages or is in engagement with the anti-rotation means.

An internal thread which is arranged therein and which is in engagement with the external thread of the spindle 40 can be configured in the opening of the valve body 50. The combination of the external thread of the spindle 40 and the internal thread of the valve body 50, in particular together with the anti-rotation means, forms a transmission unit which transfers the pure rotational movement of the spindle 40 into a translational movement of the valve body 50, with the aid of which the valve body 50 can be transferred between the fully closed position and the fully open position.

The valve body 50 can comprise a first end which tapers in the direction of the sealing seat 32. In other words, the outer circumference of the first end of the valve body 50 tapers toward the first end, such that a translational movement of the valve body in the direction of the actuator module 10 shown in FIG. 1, at the valve seat 32, releases an annular gap through which the fluid can flow, such that a fluid flow can take place between the first inlet and/or outlet opening and one or more radially arranged outlet and/or inlet openings. In the fully closed position, the valve body 50 penetrates the sealing seat 32 until the valve body 50 is pressed into the sealing seat 32 and produces an annular seal.

Alternatively, the valve body 50 can also comprise a different form and configuration as long as it can be transferred between a fully closed position and a fully open position. Optionally, additional sealing elements can be provided on the sealing seat 32 or valve body 50.

As shown in FIG. 1, a plurality of sealing elements for sealing the valve interior with respect to the surroundings are arranged between the valve body 30 and the fluid body 30.

It can be seen from the representation of the fluid valve 100 in FIG. 1 that the fluid valve 100 is constructed in a modular manner. As a result, it can be assembled easily and quickly and the replacement or repair of individual assemblies can be facilitated. In particular, the actuator module 10 can be or is connected as a whole to the valve body 20 and the spindle 40.

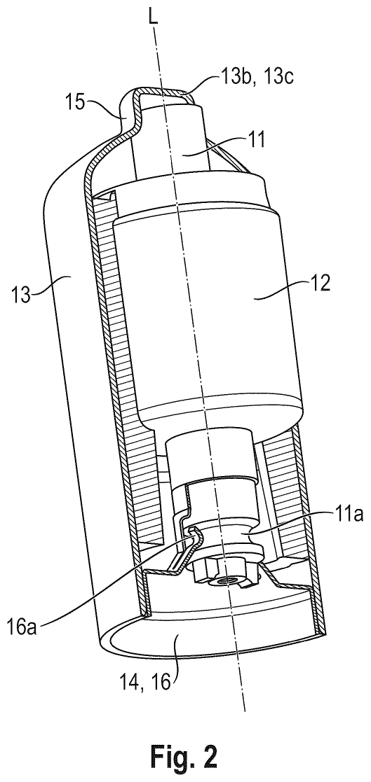

FIG. 2 shows a schematic representation of the actuator module 10 according to the invention. The features described in connection with FIG. 1 are also depicted in FIG. 2 and correspond to these features. Therefore, a repeated description will be dispensed with.

As can be seen in FIG. 2, the rotor casing 12b of the rotor 12 is provided with an inner recess on a first side which, in the installed state, corresponds to the first side 13a of the containment shroud 13. The recess serves to receive the first bearing 14 of the shaft 11 at least in regions. The contour of the recess can be shaped at least essentially in such a way that it is complementarily adapted to an outer contour of the plain bearing bushing 16. In particular, at least regions of the plain bearing bushing 16 can be received within the recess in the rotor casing 12b. The axial overall length of the actuator module 10 can therefore advantageously be limited and an extremely compact actuator module 10 can be provided.

The plain bearing bushing 16 shown in FIG. 2 is configured so as to be essentially stepped, specifically with an outer circumferential surface which can be inserted in a form-fitting manner into the containment shroud and can be fixedly connected thereto, a radial step and an oblique region which runs obliquely with respect to a cylindrically configured bulge. The cylindrically configured bulge can form the central opening which is configured to receive and support the shaft 11 in a form-fitting manner.

FIG. 2 shows an engagement element 16a which extends from the first end along the obliquely running oblique region in the direction of the shaft 11 and comprises, at the free end, a latching element in the form of a curved region which engages in the circumferential contour 11a of the shaft 11.

FIG. 2 shows the first end of the shaft 11. At the connection point to the spindle 40 (not shown in FIG. 2), the latter comprises two mutually opposite wings. These are configured to form a form-fitting rotational coupling for transmitting the rotational movement of the shaft 11 to the spindle 40.

As shown in FIG. 2, the first end of the actuator module 10, at which the plain bearing bushing 16 is arranged, is shaped in such a way that it forms a universal interface by means of which the actuator module 10 can be simply connected to a valve body 20. As a result, the actuator module 10 according to the invention can be coupled and connected to different valves in a simple and uncomplicated manner, in particular without adaptations of the connection point.

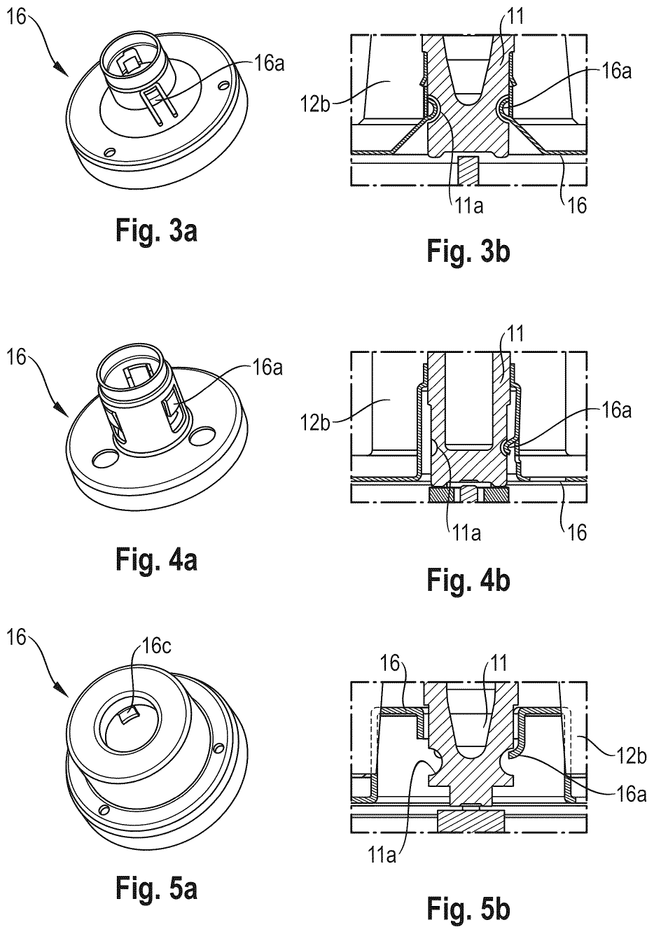

FIGS. 3 to 5 show different embodiments of the plain bearing bushing 16 (FIGS. 3a, 4a and 5a) or of the first bearing 14 (FIGS. 3b, 4b and 5b).

FIG. 3a shows a first embodiment of the plain bearing bushing 16. The latter is configured in a stepped manner. An outer circumferential surface is configured to be fixedly connected to an inner circumferential surface of the containment shroud 13 in a form-fitting manner, and in particular in a materially bonded manner.

A radially (annular) planar step extends inward from the outer circumferential surface, specifically essentially from the outer radius of the plain bearing bushing 16 as far as a first inner radius. In this context, a radially planar step is understood to mean a region which, as seen in the radial direction, forms a planar annular surface, wherein, in particular, the axial direction L corresponds to a normal to the radially planar step.

An obliquely running connecting region extends from the first inner radius as far as at least essentially a second inner radius which corresponds at least essentially to the outer radius of the shaft 11 plus the thickness of the plain bearing bushing 16. The obliquely running connecting region connects the radially planar step to an at least essentially cylindrical bulge which can be plugged onto the shaft 11. The cylindrical bulge forms the central opening of the plain bearing bushing 16.

As shown in FIG. 3a, two mutually opposite engagement elements 16a are configured in the obliquely running connecting region and in a region of the cylindrical bulge.

The engagement elements 16a each extend in the axial direction L from a first end, which is connected integrally to the plain bearing bushing 16 in the obliquely running connecting region, to a free, second end, which is arranged in a region of the cylindrical bulge, in the installed state in the direction of the second end of the shaft 11 or the second end 13b of the containment shroud 13.

At the second end of the engagement elements 16a, the engagement elements 16a are each deformed such that a respective latching element is formed which is configured to engage in the circumferential contour 11a of the shaft 11. In particular, the engagement elements 16a can each be curved such that a convexly curved side can engage in the circumferential contour 11a on the shaft 11. Alternatively, the engagement elements 16a at the free second end can each also comprise differently shaped latching geometries, such as, for example, a kink, a latching lug, a barb or the like.

FIG. 3b shows the first bearing 14 of the shaft 11 in the inserted state of the plain bearing bushing 16. The first bearing 11 is a plain bearing which is configured as the plain bearing bushing 16 shown in FIG. 3a. For this purpose, the plain bearing bushing 16 is placed onto the first end of the shaft 11. In this case, the outer circumferential surface of the plain bearing bushing 16 is inserted into the containment shroud 13 and is connected thereto in a form-fitting manner, in particular in a form-fitting and materially bonded manner.

The first end of the shaft 11 is configured to be machined in order to provide a sliding surface for the first bearing 14. Furthermore, a circumferential contour 11a, in the example shown an annular groove, is configured in the machined region. FIG. 3b also shows the end of the recess extending in the axial direction L from the second end of the shaft 11 in the shaft 11. In particular, the recess in the shaft 11 comprises, in the region of the bearing point of the first bearing 14, such a form and length that sufficient material is present for machining the sliding surface and for introducing the circumferential contour 11a. For example, the end of the recess in the shaft 11 can be configured so as to be at least essentially conically tapering.

The engagement elements 16a engage, in particular with their latching elements, in the circumferential contour 11a of the shaft 11, as a result of which the shaft 11 can be mounted axially in the plain bearing bushing 16. The shaft 11 can be mounted radially in the plain bearing bushing 16 via the reception of the shaft 11 in the cylindrical bulge of the plain bearing bushing 16. As a result, the first bearing 14 is a plain bearing which is configured as a combined radial-axial bearing.

FIGS. 4a and 4b show a second embodiment of the plain bearing bushing 16 in the non-installed state and in the installed state. In particular, the differences with respect to the aforementioned plain bearing bushing 16 will be discussed below. The remaining elements are configured according to the above embodiment and a repeated description will be dispensed with.

In contrast to the first embodiment of the plain bearing bushing 16 from FIGS. 3a and 3b, the engagement elements 16a extend from a second end of the plain bearing bushing 16 to a first end of the plain bearing bushing 16. In other words, according to the second embodiment, the first end of the engagement elements 16a forms the free end of the engagement elements 16a and the second end of the engagement elements 16a is connected integrally to the plain bearing bushing 16.

Furthermore, the second embodiment of the plain bearing bushing 16 differs from the first embodiment in that the connecting region between the radially planar step and the cylindrical bulge is also configured so as to be at least essentially cylindrical, wherein the cylindrical connecting region comprises a larger diameter than the cylindrical bulge.

FIG. 4a shows a plain bearing bushing 16 with three engagement elements 16a. The second end of the engagement elements 16a is each connected in particular integrally to the cylindrical connecting region. The engagement elements 16a can be arranged equidistant around the cylindrical connecting region. At the cylindrical connecting region, the engagement elements 16a are arranged with the free first end curved inwards in the direction of the shaft 11 such that the engagement elements can be latched or engage in the circumferential contour 11a of the shaft 11 at the free first end.

As in the embodiment described above, the engagement elements 16a each comprise latching elements at the free end. These can be formed according to the first embodiment. The shaft 11 can also be configured according to the above embodiment. As an alternative to the conically tapering end, the recess extending in the axial direction L from the second end of the shaft 11 can end in a planar region, as shown in FIG. 4b.

As in the embodiment described above, the cylindrical bulge forms the central opening of the plain bearing bushing 16 according to the second embodiment.

FIG. 4b shows the first bearing 14 of the shaft 11 in the inserted state of the plain bearing bushing 16 according to the second embodiment. The first bearing 11 is a plain bearing which is configured as the plain bearing bushing 16 shown in FIG. 4a. For this purpose, the plain bearing bushing 16 is placed onto the first end of the shaft 11. In this case, the outer circumferential surface of the plain bearing bushing 16 is inserted into the containment shroud 13 and is fixedly connected thereto in a form-fitting manner, in particular in a form-fitting and materially bonded manner.

According to the second embodiment, too, the engagement elements 16a engage, in particular with their latching elements, in the circumferential contour 11a of the shaft 11, as a result of which the shaft 11 can be mounted axially in the plain bearing bushing 16. The shaft 11 can be mounted radially in the plain bearing bushing 16 via the reception of the shaft 11 in the cylindrical bulge of the plain bearing bushing 16. As a result, the first bearing 14 is a plain bearing which is configured as a combined radial-axial bearing. FIGS. 5a and 5b show a third embodiment of the plain bearing bushing 16 in the non-mounted state and in the mounted state. In particular, the differences with respect to the aforementioned plain bearing bushings 16 will be discussed below. The remaining elements can be configured according to the above embodiments and a repeated description will be dispensed with.

As shown in FIG. 5a, the configuration of the plain bearing bushing 16 according to the third embodiment differs from those of the first and/or second embodiment.

The plain bearing bushing 16 according to the third embodiment also comprises, at the first end, an outer circumferential surface which can be received in a form-fitting manner in the first end 13 a of the containment shroud 13 and can be connected thereto, in particular in a form-fitting and materially bonded manner. Adjoining the outer circumferential surface, a radially planar step also extends inward in the third embodiment of the plain bearing bushing;

Unlike in the first and second embodiments of the plain bearing bushing 16, the connecting region adjoining the radially planar step inward is configured as a further step. In particular, the connecting region of the plain bearing bushing 16 of the third embodiment comprises a first region which is configured so as to be essentially cylindrical and extends in the axial direction L in the direction of the second end of the plain bearing bushing 16 opposite the first end, and a second region adjoining the first region radially inward and configured as a second radially (annular) planar step.

A cylindrical indentation extends in the direction of the first end of the plain bearing bushing 16 from the radially inward end of the radially annular step of the second region. In other words, a section of the plain bearing bushing 16 which is formed by the connecting region and the cylindrical indentation is configured so as to be at least essentially U-shaped in a radial semi-sectional representation. The second region of the connecting region which is formed by the second radially planar step corresponds according to the third embodiment to the second end of the plain bearing bushing 16.

Similar to the cylindrical bulge of the plain bearing bushing 16 of the first and second embodiments, the cylindrical indentation of the third embodiment of the plain bearing bushing 16 forms a recess and a bearing for the first end of the shaft 11.

Similar to the cylindrical bulge of the plain bearing bushing 16 of the first and second embodiments, the cylindrical indentation forms the central opening of the plain bearing bushing 16 according to the third embodiment.

Three engagement elements 16a are furthermore arranged projecting from the cylindrical indentation extending inward in the direction of the first end of the plain bearing bushing 16. In other words, the engagement elements 16a according to the third embodiment are connected integrally to the cylindrical indentation at their second end and extend to a free first end opposite the second end.

The three engagement elements 16a each comprise, similar to or corresponding to the engagement elements 16a of the first and second embodiments, a latching element at their free end which is configured to engage in the circumferential contour 11a of the shaft 11. The latching element can in this case be an inwardly curved end, a curved or kink region, a latching lug, a barb or the like.

The shaft 11 can also be configured according to the above embodiments. As an alternative to the conically tapering end, the recess extending in the axial direction L from the second end of the shaft 11 can also end in a planar region, as shown in FIG. 4b.

FIG. 5b shows the first bearing 14 of the shaft 11 in the inserted state of the plain bearing bushing 16 according to the third embodiment. The first bearing 11 is a plain bearing which is configured as the plain bearing bushing 16 shown in FIG. 5a. For this purpose, the plain bearing bushing 16 is placed onto the first end of the shaft 11. In this case, the outer circumferential surface of the plain bearing bushing 16 is inserted into the containment shroud 13 and is connected thereto in a form-fitting manner, in particular in a form-fitting and materially bonded manner.

According to the third embodiment, too, the engagement elements 16a engage, in particular with their latching elements, in the circumferential contour 11a of the shaft 11, as a result of which the shaft 11 can be mounted axially in the plain bearing bushing 16. The shaft 11 can be mounted radially in the plain bearing bushing 16 via the reception of the shaft 11 in the cylindrical indentation of the plain bearing bushing 16. As a result, the first bearing 14 is a plain bearing which is configured as a combined radial-axial bearing.

The plain bearing bushings 16 according to the first, second and third embodiments can also be configured with a different number of engagement elements 16a than described above.

In particular, plain bearing bushings 16 comprising only one engagement element 16a are also conceivable. In this case, the engagement element 16 is advantageously configured to be wide. For example, it can comprise a width, measured in terms of angular dimension, of 45° to 180°, preferably of 60° to 120°.

In the case of more than one engagement element 16a, it is preferred to arrange them equidistant from one another around the plain bearing bushing 16.

One or more openings, in particular openings distributed uniformly around the circumference, can each be formed in the radially planar step between the outer circumferential surface and the connecting region of the plain bearing bushing 16 of the embodiments described above, as a result of which a fluid exchange is made possible.

The plain bearing bushings 16 can be manufactured, for example, by means of deep-drawing. The engagement elements 16a can subsequently be machined by means of separating and/or forming manufacturing methods.

It is also conceivable to combine the engagement elements 16a of two of the embodiments described above in a plain bearing bushing 16. For this purpose, the connecting region between the radially planar step and the cylindrical bulge or indentation would optionally have to be correspondingly adapted, for example by a combination of the connecting regions of the corresponding embodiments. In particular in the case of a combination of the engagement element(s) 16a of the first embodiment with the engagement element(s) 16a of the second or third embodiment, a particularly secure axial bearing can be created which is insensitive to the forces which arise during the installation and connection of the actuator module 10 to the valve housing 20 and the spindle 40.

It should be noted that the features of the invention described with reference to individual embodiments or variants, such as for example type and configuration of the individual components and the precise dimensioning and spatial arrangement thereof, can also be present in other embodiments, unless otherwise specified or forbidden in itself due to technical reasons. Moreover, of such features of individual embodiments described in combination, all features do not necessarily have to be realized in a respective embodiment.

### LIST OF REFERENCE NUMERALS

L axial direction
10 actuator module
11 shaft
11a contour
12 rotor
12a core
12b casing
13 containment shroud
13a first end
13b second end
13c bulge
14 first bearing
15 second bearing
16 plain bearing bushing
16a engagement element
20 valve housing
30 fluid housing
32 valve seat
40 spindle
50 valve body
100 fluid valve

1. An actuator module for a fluid valve, comprising a shaft and a rotor arranged in a containment shroud, wherein the containment shroud comprises a first end for connection to a valve housing and a second end arranged opposite the first end, and wherein the shaft is mounted rotatably in the containment shroud at the first end by a first bearing and at the second end by a second bearing,
wherein the first bearing and the second bearing are each configured as a plain bearing, wherein the first bearing forms a combined radial-axial bearing and the second bearing forms a radial bearing.

2. The actuator module according to claim 1,
wherein the second bearing is configured in one piece with the containment shroud.

3. The actuator module according to claim 1,
wherein the second bearing is formed by a bulge of the second end of the containment shroud.

4. The actuator module according to claim 1,
wherein the first bearing is formed by a plain bearing bushing fixedly connected to the containment shroud.

5. The actuator module according to claim 4,
wherein the plain bearing bushing is configured in one piece element.

6. The actuator module according to claim 4,
wherein the plain bearing bushing comprises an engagement element supporting the shaft in a form-fitting manner in the axial direction.

7. The actuator module according to claim 6,
wherein the engagement element engages in a contour of the shaft.

8. The actuator module according to claim 7,
wherein the engagement element forms a snap or latching connection with the contour.

9. The actuator module according to claim 7,
wherein the engagement element engages in the contour of the shaft from the second end in a direction of the first end.

10. The actuator module according to claim 6,
wherein the engagement element supports the shaft at least partially in the axial direction.

11. The actuator module according to claim 6,
wherein the plain bearing bushing comprises at least two engagement elements, or at least three engagement elements.

12. The actuator module according to claim 1,
wherein the rotor comprises an outer casing, wherein the outer casing comprises a magnetizable or magnetized material.

13. The actuator module according to claim 12,
wherein the magnetizable or magnetized material comprises neodymium.

14. The actuator module according to claim 12,
wherein the magnetizable or magnetized material is embedded in a plastic material.

15. The actuator module according to claim 1,
wherein the shaft is formed from a plastic material.

16. A fluid Fluid-valve comprising an actuator module according to claim 1.

17. The actuator module according to claim 3, wherein the bulge is cylindrical.

18. The actuator module according to claim 11, wherein the at least two engagement elements are arranged opposite one another, or
the at least three engagement elements are arranged equidistant from one another.

19. The actuator module according to claim 12, wherein the magnetizable or magnetized material consists of neodymium.
